(19) United States
(12) Patent Application Publication
(10) Pub. No.: US 2025/0085049 A1
(43) Pub. Date: Mar. 13, 2025

(54) APPARATUS AND METHOD FOR PRODUCING DRY ICE

(71) Applicant: SNF Group, ANDREZIEUX-BOUTHEON (FR)

(72) Inventor: Danilo BOMBARDI, VAREDO (IT)

(21) Appl. No.: 18/883,045

(22) Filed: Sep. 12, 2024

(30) Foreign Application Priority Data
Sep. 12, 2023 (IT) 102023000018708

(51) Int. Cl. F25J 1/00

(52) U.S. Cl. CPC F25J 1/0027; F25J 2210/80; F25J 2245/90

(57) ABSTRACT

An apparatus for producing dry ice includes a supply means (2) for supplying carbon dioxide in the liquid state and a means (20) for the transition of state of the carbon dioxide in the liquid state flowing along the supply means (2). The state transition means (20) brings about the desired solidification of the carbon dioxide in order to produce dry ice and the undesired formation of carbon dioxide in the gaseous state. A system (3) is provided for the collection and recovery of carbon dioxide in the gaseous state. The collection and recovery system (3) collects carbon dioxide in the gaseous state downstream of the state transition means (20) and has a compressor (4) for compressing the carbon dioxide collected by the collection system (3), a heat exchanger (5) that places the carbon dioxide downstream of the compressor (4) and the carbon dioxide upstream of the compressor (4) in thermal communication, and a storage means (6) for storing the carbon dioxide coming from the compressor (4).

### RELATED APPLICATION

This application claims the benefit of priority from Italian Patent Application No. 102023000018708, filed on Sep. 12, 2023, the entirety of which is incorporated by reference.

### FIELD OF THE INVENTION

The present invention relates to an apparatus and a method for producing dry ice.

### DESCRIPTION OF RELATED ART

There are known solutions that provide for liquid carbon dioxide to be supplied to a throttling member. This brings about an expansion with the production of dry ice.

One drawback of this solution is tied to the fact that during the production of dry ice, a considerable part of the carbon dioxide passes into the gaseous state, which, being volatile, is thus dispersed in the environment.

### OBJECTS AND SUMMARY

The object of the present invention is to propose an apparatus and a method for producing dry ice which enables the available resources to be optimised while minimising the risk of the above-described drawbacks.

The stated technical task the specified objectives are substantially achieved by an apparatus and a method comprising the following technical features.

In more details, the invention concerns an apparatus for producing dry ice comprising:
a supply means for supplying carbon dioxide in the liquid state;
a means for the transition of at least a part of the carbon dioxide flowing along the supply means from the liquid to the solid state, said state transition means bringing about the desired solidification of the carbon dioxide in order to produce dry ice and the undesired formation of carbon dioxide in the gaseous state;
a system for the collection and recovery of carbon dioxide in the gaseous state; said collection and recovery system collecting carbon dioxide in the gaseous state downstream of the state transition means and comprising:
i) a compressor for compressing the carbon dioxide collected downstream of the state transition means;
ii) a storage means for storing the carbon dioxide coming from the compressor.

The apparatus is characterised in that:
the compressor is a volumetric piston compressor which is able to compress the outflowing carbon dioxide at a pressure comprised between 25 and 28 bar,
the collection and recovery system comprises a heat exchanger that places the carbon dioxide downstream of the compressor and the carbon dioxide upstream of the compressor in thermal communication,
the storage means is a means for storing liquid carbon dioxide under pressure between 18 and 20 bar.

The apparatus of the invention also comprises at least one of the following features:
the said exchanger is a plate exchanger,
the system for the collection and recovery of carbon dioxide comprises a line for the flow of the carbon dioxide collected downstream of the means to the storage means, said flow line comprising:
   a first section situated upstream of the heat exchanger;
   a second section which extends downstream of an intermediate outlet from the exchanger and upstream of an intermediate inlet into the exchanger;
   a third section downstream of the exchanger.
the system for the collection and recovery of carbon dioxide further comprises electrical heaters located in the first section between the exchanger and the compressor,
the collection and recovery system comprises a non-return valve interposed between the compressor and the storage means,
the collection and recovery system comprises a homogeniser placed between the compressor and the storage means.

The invention also concerns a method for producing dry ice comprising the steps of:
causing at least a part of liquid carbon dioxide to solidify, thus obtaining dry ice through a state transition means; said state transition means bringing about the desired solidification of the carbon dioxide in order to produce dry ice and the undesired formation of carbon dioxide in the gaseous state;
collecting, downstream of the state transition means, carbon dioxide in the gaseous state;
compressing said carbon dioxide in the gaseous state by means of a compressor having the form of a volumetric piston compressor compressing the outflowing carbon dioxide at a pressure comprised between 25 and 28 bar, thereby transforming said gaseous carbon dioxide into liquid carbon dioxide;
storing said liquid carbon dioxide in a storage means under pressure between 18 and 20 bar,
effecting a heat exchange between the liquid carbon dioxide present downstream of the compressor having a temperature from 15 to 20° C. and the gaseous carbon dioxide present upstream of the compressor having a temperature from −70 to −78.5° C.

### BRIEF DESCRIPTION OF THE DRAWINGS

Additional features and advantages of the present invention will emerge more clearly from the approximate, and thus non-limiting, description of an apparatus and a method for producing dry ice as illustrated in the appended figures, in which:

FIG. 1 shows a schematic view of an apparatus for producing dry ice according to the present invention;

FIG. 2 shows a system for the collection and recovery of carbon dioxide in an apparatus for producing dry ice according to the present invention.

### DETAILED DESCRIPTION

In the appended figure, the reference number 1 indicates an apparatus for producing dry ice (or more in general carbon dioxide in the solid state).

The apparatus 1 comprises a supply means 2 for supplying carbon dioxide in the liquid state.

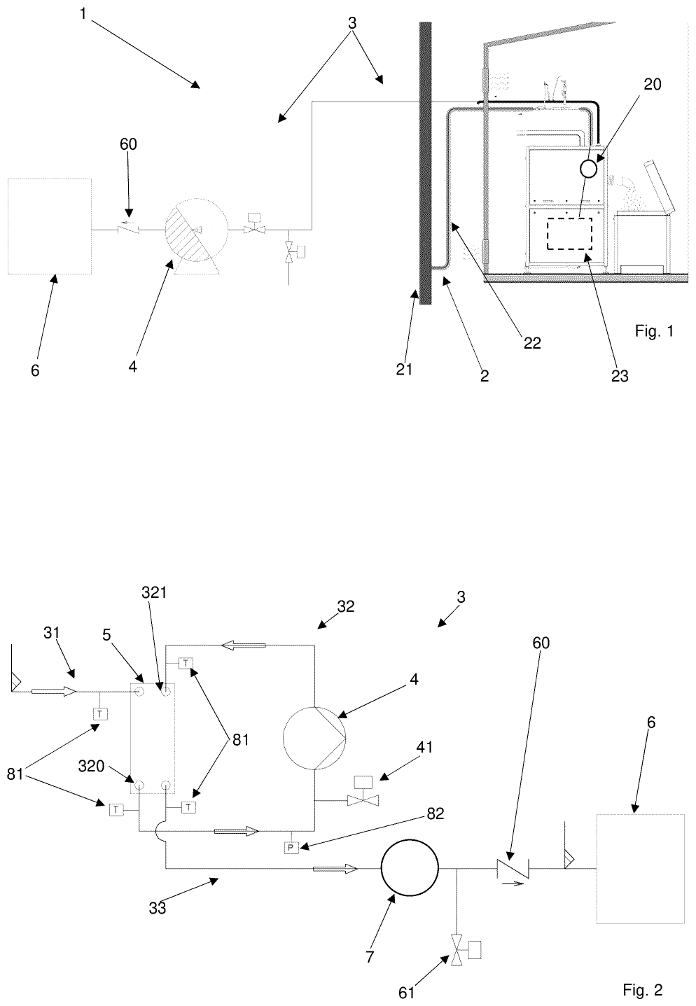

This supply means 2 conveniently comprises a tank 21. The supply means 2 comprises a conveyor line 22 for conveying the carbon dioxide in the liquid state which conveniently extends from/downstream of the tank 21 (see FIG. 1). Conveniently, the carbon dioxide in the tank 21 is at a temperature of less than −18° C., practically between −20 and −25° C., and a pressure greater than 7 bar, especially between 18 and 20 bar.

The apparatus 1 comprises a means 20 for the transition of at least a part of the carbon dioxide in the liquid state flowing along the supply means 2 (or more precisely along the conveyor line 22) from the liquid to the solid state. The state transition means 20 brings about the desired solidification of the carbon dioxide in order to produce dry ice and the undesired formation of carbon dioxide in the gaseous state. The means 20 comprises/is a throttling means. Typically, the means 20 comprises/is a throttling valve. The apparatus 1 conveniently comprises a collection tank 23 for collecting the dry ice.

The apparatus 1 comprises a system 3 for the collection and recovery of carbon dioxide in the gaseous state. The collection and recovery system 3 collects carbon dioxide in the gaseous state downstream of the state transition means 20. Conveniently, the collection and recovery system 3 collects carbon dioxide in the gaseous state at the collection tank 23. Therefore, the carbon dioxide which for any reason is not transformed into dry ice can be reused.

The collection and recovery system 3 comprises a compressor 4 for compressing the carbon dioxide collected by the collection system 3.

Preferably, the compressor 4 is a volumetric compressor. Even more preferably, the compressor 4 is a piston compressor.

Conveniently, the compressor 4 has a liquid separator on the inlet side. Conveniently, the compressor 4 has a particularly efficient two-stage oil separator on the outlet side.

Preferably, the compressor 4 compresses the outgoing carbon dioxide at a pressure comprised between 25 and 28 bar.

The collection and recovery system 3 comprises a storage means 6 for storing the carbon dioxide coming from the compressor 4. The storage means 6 can comprise a pressure vessel, for example a pressurised cylinder. The storage means 6 is a means for storing liquid carbon dioxide under pressure, especially between 17 and 25 bar, preferably between 17 and 22 bar, advantageously between 18 and 20 bar. Therefore, the carbon dioxide can be recovered (advantageously in liquid form) in order then to be reused in the system for producing dry ice.

The collection and recovery system 3 comprises a heat exchanger 5 that places the carbon dioxide downstream of the compressor 4 and the carbon dioxide upstream of the compressor 4 in thermal communication. In particular, the heat exchanger 5 places the carbon dioxide immediately downstream of the compressor 4 and the carbon dioxide upstream of the compressor 4 in thermal communication. Advantageously, the exchanger 5 is a plate exchanger, preferably a cross-flow plate exchanger. The thermal communication allows to decrease the temperature of the gaseous carbon dioxide before its entry in the compressor from a range of temperature between −70 to −78.5° C., to around a temperature comprised between −40 and −45° C. in order to liquefy it in the volumetric piston compressor. The presence of the said thermal communication optimises the functioning of the volumetric piston compressor and saves energy.

Conveniently, the collection system 3 comprises a line 30 for the flow of the carbon dioxide collected downstream of the means 20 to the storage means 6. This flow line 30 advantageously comprises:
a first section 31 situated upstream of the heat exchanger 5;
a second section 32 which extends downstream of an intermediate outlet 320 from the exchanger 5 and upstream of an intermediate inlet 321 into the exchanger 5 (the compressor 4 is located along the second section 32);
a third section 33 downstream of the exchanger 5.

Conveniently
between the exchanger 5 and the compressor 4 (in the second section 32) the gaseous carbon dioxide is at a temperature comprised between −45 and −40° C.,
between the compressor 4 and the exchanger 5 (in the second section 32), the liquefied carbon dioxide is at a temperature comprised between 15 and 20° C.,
immediately downstream of the exchanger 5 (in the third section 33) the liquid carbon dioxide is at a temperature comprised between −10 and −40° C., preferably between −25 and −30° C.

The first, the second and the third sections 31, 32, 33 define a same channel. They are arranged after one another in series.

The carbon dioxide in the first section 31 is used to cool the carbon dioxide in the third section 33.

In the present description, the expressions “upstream of” and “downstream of” are to be understood with reference to the direction of flow of the carbon dioxide.

Upstream of the compressor 4, the system 3 can comprise a safety valve 41 (it is conveniently located upstream of the compressor 4 and downstream of at least a portion of the exchanger 5; it is conveniently located in the second section 32). The safety valve 41 allows the by-passing of the compressor 4 or release of carbon dioxide. The safety valve 41 can be a motorised valve.

Conveniently, the carbon dioxide immediately upstream of the exchanger 5 (in the first section 31) is at about 1 bar and advantageously at a temperature of less than −76.8° C., for example at a temperature of −78.5° C., practically between −70° C. and −78.5° C. Conveniently, the liquid carbon dioxide immediately downstream of the compressor 4 (in the second section 33) is at a pressure comprised between 25 and 28 bar, and at a temperature comprised between 15 and 20° C. Conveniently, immediately upstream of the heat exchanger 5 (for example in the first section 31) there is a flow rate of carbon dioxide comprised between 300 and 500 m³/h, preferably about 400 m³/h. Advantageously, immediately upstream of the heat exchanger 5 there is a flow rate of carbon dioxide comprised between 700 and 900 kg/h, preferably about 800 kg/h.

Advantageously, the system 3 comprises a non-return valve 60 interposed between the compressor 4 and the storage means 6 (for example in the third section 33).

This prevents/limits the return of carbon dioxide present in the storage means 6.

A safety valve 61 can be present between the compressor 4 and the non-return valve 60 (for example in the third section 33). The safety valve 61 allows the by-passing of the valve 60 or the release of carbon dioxide. The safety valve 61 can be a motorised valve.

In a particular solution, the system 3 could optionally comprise a homogeniser 7. Conveniently, the homogeniser 7 is placed between the compressor 4 and the storage means 6 (typically in the third section 33).

The homogeniser 7 makes it possible, for example, to compress the carbon dioxide at a pressure also greater than 100 bar, conveniently also comprised between 200 and 250 bar. In this manner, storage can take place in the means 6 at a greater pressure. Downstream the homogeniser, the temperature is between −20 and −25° C.

Conveniently, the system 3 can comprise one or more temperature sensors 81; for example, in the solution in FIG. 2 one temperature sensor is present in the first section 31, two temperature sensors in the second section 32 (one upstream and one downstream of the compressor 4) and a temperature sensor in the third section 33.

Conveniently, the system 3 can comprise some electrical heaters (non-represented on the figures) located in the first section 31 between the heat exchanger 5 and the compressor 4. In case the temperature of the gaseous carbon dioxide is too low between its entry in the compressor 4, the electrical heaters adjust the temperature to a range from −40 and −45° C.

Conveniently, the system 3 can comprise one or more pressure sensors 82 (for example in the solution in FIG. 2 it is placed downstream of a portion of the exchanger 5 and upstream of the compressor 4). The pressure measure by this specific sensor is around 5 bar.

The subject matter of the present invention relates to a method for producing dry ice. In particular, it is a method for producing dry ice that envisages at least a partial recovery of the carbon dioxide not transformed into dry ice. More in general, it can also be defined as an apparatus for treating liquid carbon dioxide. Conveniently, this method is implemented by an apparatus 1 for producing dry ice having one or more of the previously described features. The method comprises the steps of causing the (liquid) carbon dioxide to solidify, thus obtaining dry ice. This is typically obtained with a state transition means 20 (typically a throttling means).

The state transition means 20 brings about the desired solidification of the carbon dioxide in order to produce dry ice and the undesired formation of carbon dioxide in the gaseous state.

There is thus a transition of the carbon dioxide from a liquid to a solid state. This is obtained by expanding the carbon dioxide in a throttling means.

The method also comprises collecting, downstream of the state transition means 20, carbon dioxide in the gaseous state.

The method also comprises a step of compressing said carbon dioxide in the gaseous state by means of a compressor 4, thereby transforming it into liquid carbon dioxide.

The method comprises a step of storing said liquid carbon dioxide in a storage means 6.

Conveniently, the method can comprise a step of effecting a heat exchange between the carbon dioxide present downstream of the compressor 4 having practically a temperature from 15 to 20° C. and the carbon dioxide present upstream of the compressor 4. having practically a temperature from −70 to −78.5° C. Conveniently, this heat exchange takes place in a heat exchanger 5. The carbon dioxide present downstream of the compressor 4 and the carbon dioxide present upstream of the compressor 4 (which are thermal communication via the heat exchanger 5) flow along a same conveyor line. This allows the carbon dioxide present downstream of the compressor 4 to be cooled with the carbon dioxide present upstream of the compressor 4. This arrangement in combination with a volumetric piston pump saves energy.

The present invention achieves important advantages.

First of all, it enables, in the production of dry ice, a recovery of volatile carbon dioxide. This reduces the consumption of raw materials and energy consumption.

The invention thus conceived is susceptible of numerous modifications and variants, all falling within the scope of the inventive concept which characterises it. Moreover, all of the details may be replaced by technically equivalent elements. All the materials used, as well as the dimensions, may in practice be any whatsoever, according to needs.

1. An apparatus for producing dry ice comprising:
a supply means for supplying carbon dioxide in the liquid state;
a means for the transition of at least a part of the carbon dioxide flowing along the supply means from the liquid to the solid state, said state transition means bringing about the desired solidification of the carbon dioxide in order to produce dry ice and the undesired formation of carbon dioxide in the gaseous state;
a system for the collection and recovery of carbon dioxide in the gaseous state; said collection and recovery system collecting carbon dioxide in the gaseous state downstream of the state transition means and comprising:
i) a compressor for compressing the carbon dioxide collected downstream of the state transition means;
ii) a storage means for storing the carbon dioxide coming from the compressor,
wherein,
the compressor is a volumetric piston compressor which is able to compress the outflowing carbon dioxide at a pressure comprised between 25 and 28 bar,
the collection and recovery system comprises a heat exchanger that places the carbon dioxide downstream of the compressor and the carbon dioxide upstream of the compressor in thermal communication,
the storage means is a means for storing liquid carbon dioxide under pressure between 18 and 20 bar.

2. The apparatus according to claim 1, wherein said exchanger is a plate exchanger.

3. The apparatus according to claim 1, wherein the system for the collection and recovery of carbon dioxide comprises a line for the flow of the carbon dioxide collected downstream of the means to the storage means, said flow line comprising:
a first section situated upstream of the heat exchanger;
a second section which extends downstream of an intermediate outlet from the exchange and upstream of an intermediate inlet into the exchanger;
a third section downstream of the exchanger.

4. The apparatus according to claim 3, wherein the system for the collection and recovery of carbon dioxide further comprises electrical heaters located in the first section between the exchanger and the compressor.

5. The apparatus according to claim 1, wherein the collection and recovery system comprises a non-return valve interposed between the compressor and the storage means.

6. The apparatus according to claim 1, wherein the collection and recovery system comprises a homogeniser placed between the compressor and the storage means.

7. A method for producing dry ice comprising the steps of:
causing at least a part of liquid carbon dioxide to solidify, thus obtaining dry ice through a state transition means; said state transition means bringing about the desired solidification of the carbon dioxide in order to produce dry ice and the undesired formation of carbon dioxide in the gaseous state;
collecting, downstream of the state transition means, carbon dioxide in the gaseous state;
compressing said carbon dioxide in the gaseous state by means of a compressor having the form of a volumetric piston compressor compressing the outflowing carbon dioxide at a pressure comprised between 25 and 28 bar, thereby transforming it into liquid carbon dioxide;
storing said liquid carbon dioxide in a storage means under pressure between 18 and 20 bar,
effecting a heat exchange between the liquid carbon dioxide present downstream of the compressor having a temperature from 15 to 20° C. and the gaseous carbon dioxide present upstream of the compressor having a temperature from −70 to −78.5° C.
